(19) United States
(12) Patent Application Publication
(10) Pub. No.: US 2013/0164428 A1
(43) Pub. Date: Jun. 27, 2013

(54) ICE CREAM FORMULATIONS AND METHODS OF MANUFACTURE

(71) Applicants: Jon Gordon, Rancho Mirage, CA (US); Candice Johnston, Rancho Mirage, CA (US)

(72) Inventors: Jon Gordon, Rancho Mirage, CA (US); Candice Johnston, Rancho Mirage, CA (US)

(21) Appl. No.: 13/261,441

(22) PCT Filed: Sep. 5, 2008
(86) PCT No.: PCT/US08/75325

§ 371 Date: Sep. 25, 2012

Related U.S. Application Data
(60) Provisional application No. 60/967,716, filed on Sep. 5, 2007.

(51) Int. Cl. A23G 9/32

(52) U.S. Cl. CPC A23G 9/32
USPC 426/548; 426/474

(57) ABSTRACT

The present invention relates to an improved ice cream formation and method of making said formulation where the formulation is sugar free. The inventive ice cream is made through a complex, multi-phase process utilizing fat globules, ice crystals and air cells producing a highly viscous frozen concentrate.

### BACKGROUND OF THE INFORMATION

Ice cream is a popular food and snack. Numerous formulations in many flavors exist. One problem, however, with presently existing ice cream formulations is that they contain sugar. In addition to weight gain concerns for consumers in general, the presence of sugar in the ice cream presents clear danger to a consumer who is diabetic. Accordingly, there is a need for an ice cream which is sugar free. In addition, there is a need for sugar free ice cream which is palatable.

### SUMMARY OF THE INVENTION

The present invention solves the above problems by providing for palatable, sugar free ice cream. In addition, methods of making said palatable sugar free ice cream are provided herein.

More specifically, the presently inventive ice cream is a product that is manufactured through a complex, multi-phase process utilizing fat globules, ice crystals and air cells producing a highly viscous frozen concentrate. The microstructure of these ingredients determines in large part the core sensory elements such as smooth texture and mouth feel that are critical to the consumer experience with the product. Thus the ability to manipulate the core ingredients to achieve these desired characteristics is quite important. In its frozen composition, the texture and creaminess of ice cream is predominately dictated by the ice crystals. It is the fat globules and air cells combined as a foam-like composition that are most critical when ice cream is in a thawed state during the manufacturing process. The ability to manage the stability of the foam during manufacturing is critical when ice cream is in a thawed state during the manufacturing is critical to the richness and creamy texture of the product, which is a highly desired outcome for consumers. By reducing the size of the air cells and increasing and coalescence of the fat globules we can increase the foam's overall coalescence to achieve this outcome. In the inventive process, stability of the foam as it enters the freezing process is controlled by a Variable Retention Time (VRT) high air velocity hardening system. The VRT process aids in preventing heat shock and helps retain the small air cell size. The system sets the product structure by freezing it rapidly at about −40° F. to about a 0 degree core temperature within a short period of time which preserves the ice and air cell structure. Prior to entry to the VRT hardening, a pre-whipping shear pump reduces the size of the air cells by spreading the product onto a large surface area that mitigates heat shock and air release The VRT process, with superior freezing performance and heat shock resistance, yields a product with maximum air cell diameter that is reduced from about 52 m to about 19 m. The process thus delivers the physical and sensory characteristics that consumer's desire.

### DETAILED DESCRIPTION OF THE INVENTION

The following is a detailed description of the manufacture of the inventive ice cream and several representative formulations.

A. Process of Making Naturally Sugar Free Ice Cream

This invention relates to the process of making naturally sugar free ice cream on a commercial basis.

### Mixing Process

In a large steam vat heavy cream, water, egg yolks and maltitol are thoroughly mixed with xylitol, salt, fibersol maltodextrim and stabilizer. While mixing constantly, the mix is then heated to a 190° F. to pasteurize the mix. Pasteurizing is done to kill possible bacteria and disable certain enzymes, and so not to affect the flavor of them mix. The mix is then homogenized. This is done by pushing the mix through tiny tubes with extremely high pressure to break up fat globules into small sizes to aid in properly emulsifying the mix. Adding the flavorings, and/or extracts, to the mix is the final step of the mixing process before cooling and placing in refrigeration.

### Aging Process

After the mix has gone through the mixing stage, it optionally proceeds to an aging process. Here, the mix is allowed to age refrigerated, at a temperature of about 40° F. to about 18° F., more preferably at a temperature of about 40° F., for preferably a minimum of 6 to 12 hours for the flavorings to enhance the mix properly, and to allow the emulsion of the mix to set properly. In any event, even if the aging process is not used, the mix is preferably allowed to cool to a temperature of about 40° F.

### Freezing Process

Whether or not the aging process is used, the mix is then transferred to a vat to agitate, and then fed into a continuous ice cream freezer. Preferably, the mix is cooled to a temperature of about 23-24° F. The lines draw the mix into freezing chambers that will add over run to the mix, churn and freeze the mix into ice cream composition. Preferably, the over run is added while the mix is freezing. This ice cream composition can then have inclusions (i.e. nuts or chips) and/or variegates (i.e. chocolate or caramel sauces) added to enhance particular desired flavors. The composition is then extruded into the set units for distribution, preferably at a temperature of about 23-24° F. The ice cream is then placed into a VRT (Variable Retention Time) system at temperatures ranging from 0 to -75° F. preferably at a temperature of about −70° F., to fast freeze the product to ensure the highest quality flavored ice cream. The ice cream can then be stored at a temperature preferably about −10° to -20° F.

In a preferred embodiment, the mix is pumped into a barrel freezer. The barrel freezer has blocks or paddles that scrape the inner sidewalls of the barrel. During this process, air is forced into the barrel, mixing with the mix to the desired over run level.

B. Formulations

In the following formulations, the percentages of ingredients are percent by weight. The phrase “Over Run” relates to the amount of air put into the ice cream.

These formulations comprise pasteurized, homogenized, naturally sugar free ice cream sweetened with a mixture of polyols, fat content of about 20%, over run of about 40-75%, preferably about 70%, with reduced air cell size, about 13 g of polyol mixture, 0 g sugar for a GL range of about 5.5-13, no trans fat, about 1 g protein, about 14 g of dietary fiber from maltodextrin, and a natural stabilizer.

1. Vanilla Ice Cream (40-75% Over Run)

| | |
|---|---|
| Milk Fat | 20.00% |
| MSNF | 3.15% |
| Maltitol (Solids) | 11.90% |
| Xylitol (Solids) | 5.10% |
| Egg Yolks (Solids) | 2.00% |
| Whole Egg (Solids) | 1.00% |
| Inulin | 4.00% |
| Salt | .05% |
| Fibersol Maltodextrin | .15% |

### Added Flavoring & Inclusions:

.04% Vanilla Specks (Virginia Dare)

.95% Vanilla Extract (Virginia Dare)

### Process—

*Mix all heavy cream, water, eggs, egg yolks, maltitol
*Add xylitol, inulin, salt and fibersol maltodextrin to mix
* While mixing thoroughly, pasteurize mix to 190 F
*Homogenize mix with Homogenizer
*Add vanilla extract and vanilla seeds
*Cool and refrigerate for minimum 6 hour aging
*Place batch into ice cream machine for freezing and incorporating 75% over run
*Extrude into desired cups (Quarts/Pints)
*Place ice cream into VRT at −25 F for final freezing process

2. Chocolate Ice Cream (40-75% Over Run)

| | |
|---|---|
| Milk Fat | 20.00% |
| MSNF | 3.15% |
| Maltitol (Solids) | 19.72% |
| Xylitol (Solids) | 0.03% |
| Egg Yolks (Solids) | 2.00% |
| Whole Egg (Solids) | 1.00% |
| Barry Cocoa (Natural) | 4.85% |
| Fibersol Maltodextrin | 4.00% |
| Salt | .05% |
| Stabilizer | .15% |

### Added Flavoring & Inclusions:

.025% Vanilla Specks (Virginia Dare)

.25% Vanilla Extract (Virginia Dare)

.09% Chocolate Flavoring (Ivory Coast Natural-C20582)

### Process—

*Mix all heavy cream, water, eggs, egg yolks, maltitol
*Add Barry Cocoa (natural), xylitol, stabilizer, salt and fibersol maltodextrin to mix
*While mixing thoroughly, pasteurize mix to 190 F
*Homogenize mix with Homogenizer
*Add vanilla extract, vanilla seeds and chocolate flavoring
*Cool and refrigerate for minimum 6 hour aging
*Place batch into ice cream machine for freezing and incorporating 75% over run
*Extrude into desired cups (Quarts/Pints)
*Place ice cream into VRT at −25 F for final freezing process

3. Toasted Almond Ice Cream (40-75% Over Run)

| | |
|---|---|
| Milk Fat | 20.00% |
| MSNF | 3.15% |
| Maltitol (Solids) | 13.30% |
| Xylitol (Solids) | 5.70% |
| Egg Yolks (Solids) | 2.00% |
| Whole Egg (Solids) | 1.00% |
| Inulin | 4.00% |
| Salt | .05% |
| Fibersol Maltodextrin | .15% |

### Added Flavoring & Inclusions:

.022% Vanilla Specks (Virginia Dare)

.225% Vanilla Extract (Virginia Dare)

2.25% Almond Extract (Dean Michael's Natural SF Extract)

23.5% Almond Inclusions (Almond Brittle/Pecan Deluxe)

### Process—

*Mix all heavy cream, water, eggs, egg yolks, maltitol
*Add xylitol, inulin, salt and fibersol maltodextrin to mix
*While mixing thoroughly, pasteurize mix to 190 F
*Homogenize mix with Homogenizer
*Add almond extract, almond inclusions, vanilla extract and vanilla seeds
*Cool and refrigerate for minimum 6 hour aging
*Place batch into ice cream machine for freezing and incorporating 75% over run
*Extrude into desired cups (Quarts/Pints)
*Place ice cream into VRT at −25 F for final freezing process

4. Coffee Ice Cream (40-75% Over Run)

| | |
|---|---|
| Milk Fat | 20.00% |
| MSNF | 3.15% |
| Maltitol (Solids) | 13.30% |
| Xylitol (Solids) | 5.70% |
| Egg Yolks (Solids) | 2.00% |
| Whole Egg (Solids) | 1.00% |
| Inulin | 4.00% |
| Salt | .05% |
| Fibersol Maltodextrin | .15% |

### Added Flavoring & Inclusions:

.025% Vanilla Specks (Virginia Dare)

.25% Vanilla Extract (Virginia Dare)

1.45% Instant Espresso (Medalia D'oro)

### Process—

*Mix all heavy cream, water, eggs, egg yolks, maltitol
*Add xylitol, inulin, salt and fibersol maltodextrin to mix
*While mixing thoroughly, pasteurize mix to 190 F
*Homogenize mix with Homogenizer
*Add instant espresso, vanilla extract and vanilla seeds
*Cool and refrigerate for minimum 6 hour aging
*Place batch into ice cream machine for freezing and incorporating 75% over run
*Extrude into desired cups (Quarts/Pints)
*Place ice cream into VRT at −25 F for final freezing process

5. Mint Chocolate Swirl Ice Cream (40-75% Over Run)

| | |
|---|---|
| Milk Fat | 20.00% |
| MSNF | 3.15% |
| Maltitol (Solids) | 13.30% |
| Xylitol (Solids) | 5.70% |
| Egg Yolks (Solids) | 2.00% |
| Whole Egg (Solids) | 1.00% |
| Inulin | 4.00% |
| Salt | .05% |
| Fibersol Maltodextrin | .15% |

### Added Flavoring & Inclusions:

.04% Vanilla Specks (Virginia Dare)

.95% Vanilla Extract (Virginia Dare)

.68% Crème de Menthe Extract (Yarnell's)

14.0% Chocolate Variegate (Natural/SF-Pecan Deluxe)

### Process—

*Mix all heavy cream, water, eggs, egg yolks, maltitol
*Add xylitol, inulin, salt and fibersol maltodextrin to mix
*While mixing thoroughly, pasteurize mix to 190 F
*Homogenize mix with Homogenizer
*Add crème de menthe, vanilla extract, vanilla seeds and chocolate variegate
*Cool and refrigerate for minimum 6 hour aging
*Place batch into ice cream machine for freezing and incorporating 75% over run
*Extrude into desired cups (Quarts/Pints)
*Place ice cream into VRT at −25F for final freezing process

Although described in detail above, the present invention is not limited to the specific ingredients and concentrations set forth therein, but rather can be varied according to the art.

What is claimed is:

1. A pasteurized, homogenized naturally sugar free ice cream comprising in a 4 oz portion about 13 g of polyol mixture, milk fat content of about 20%, over run of about 40-75%, 0 g of sugar, no trans fat, about 1 g protein, about 14 g fibersol maltodextrin and a natural stabilizer.

2. The ice cream of claim 1 wherein the polyol mixture comprises a mixture of xylitol and maltitol.

3. The ice cream of claim 1 which has a glycemic level of 5.5 - 13.

4. The ice cream of claim 1 with a milk fat content of 20%.

5. The ice cream of claim 1, wherein said over run is about 70%.

6. A method of making a pasteurized, homogenized naturally sugar free ice cream comprising, in a 4 oz portion, about 13 g of polyol mixture, milk fat content of about 20%, over run of about 40-75%, about 1 g of protein, about 14 g fibersol maltodextrin and a natural stabilizer, said method comprising:
a. mixing said ingredients together;
b. pasteurizing said mixture;
c. freezing said mixture; and
d. forcing air into said mixture in an amount sufficient to provide for an over run of about 40-75%

7. The method of claim 6 wherein the air is forced into the mixture while the mixture is freezing.

8. The method of claim 6 wherein the polyol mixture comprises a mixture of xylitol and maltitol.

9. The method of claim 6, where the over run is about 70%.

10. The method of claim 6, wherein the ice cream has a glycerin level of 5.5-13.

11. The method of claim 6, wherein the ice cream has a milk fat content of 20%.

12. The method of claim 6, wherein after the air is forced into the mixture to provide for the over run, the mixture is then placed into a Variable Time Retention system at a temperature ranging from about 0° F. to about −75° F. to fast freeze the mixture.
